(19) United States
(12) Patent Application Publication
(10) Pub. No.: US 2014/0372485 A1
(43) Pub. Date: Dec. 18, 2014

(54) SYSTEM AND METHOD FOR MANAGING PERSONAL AND PROFESSIONAL CONTACT INFORMATION

(71) Applicant: Matthew Crumrine, Brooklyn, NY (US)

(72) Inventor: Matthew Crumrine, Brooklyn, NY (US)

(73) Assignee: ATMOSPHEIR, LLC, Brooklyn, NY (US)

(21) Appl. No.: 14/304,344

(22) Filed: Jun. 13, 2014

Related U.S. Application Data
(60) Provisional application No. 61/835,128, filed on Jun. 14, 2013.

(51) Int. Cl. G06F 17/30

(52) U.S. Cl. CPC G06F 17/30699
USPC 707/784

(57) ABSTRACT

The present invention encompasses a system and method for managing and sharing personal and professional contact information. The present invention allows users to exchange distinct and complete information profiles that are tied to an individual user ID and allows users to manage themselves and contacts as relationships, information and points of contact change.

### BACKGROUND OF THE INVENTION

The present invention relates to a comprehensive system and method for managing and sharing personal and professional contact information. Contact information has historically been overwhelming to record, update, share and control. It becomes increasingly difficult every passing day, as available methods of communication continue to evolve and increase—and each of us acquires myriad points of contact. While there are countless address book options to choose from, none allow us to quickly exchange complete information, including social media profiles, and manage our contacts as our relationships, information, connections and choice of media evolves. Present systems fail to provide a way to give different comprehensive information profiles to different types of contacts, to ensure we have all the information we need when we're mobile, to avoid time lost keeping address books up-to-date, to efficiently transition to new and better communication channels, to guarantee contact information exchanged is accurately stored, and to provide an intrinsic layer of privacy to a user of the system.

Only the solution that confronts each and every underlying issue related to contact management will provide a complete and perpetual solution to the complex and evolving problem of contact management. The system must evolve along with its users.

### SUMMARY OF THE INVENTION

The present invention provides a system and method for users to exchange and manage distinct and complete contact information profiles with a user-created alpha/numeric identifier (hereinafter “ID”).

The present invention comprises a system and method that assists users in storing, sharing, locating, updating, accessing and using information with other users of the system.

Systems in accordance with the present invention contemplate individual user IDs created by the users of the system. Systems in accordance with the present invention contemplate that users can find another user by searching for that user's specific, and unique, ID. Users will then have the option to request a connection with the discovered user. Users can also request an introduction through already-established connections, where users have permitted other users to make an introduction, make introductions between established connections, or when users have chosen to make themselves visible to other users via a Bluetooth enabled “around me” function, make connections with fellow users within 50 meters of said user's location. Privacy is achieved by managing your contact information in a forum where you control access to your information and is ensured by the absence of a full-scale public search.

In one embodiment, the system encompasses a mobile user interface through which each user can create an account, establish a unique ID, establish contact relationships with other users, and specify a sharing level for allowing other users to access the respective user's own personal and professional data and contact data.

One embodiment of the present invention encompasses a computer-implemented method for connecting a user of the presently described system to another user of the presently described system, comprising the steps of inviting another user to connect, identifying the sharing level of the connection, notifying the user of the invitation, and providing the user with the option to accept, and share an information level back, or deny the invitation. The choice of sharing level between two users can be mutually exclusive, meaning they do not have to be sharing the same level with each other.

Another embodiment of the present invention contemplates a network-based system and method for managing and sharing personal and professional contact information comprising at least one processor, a user interface for imputing user data, at least one database for storing user data, and user created IDs associated with stored user data, wherein the system is configured to assist users in storing, locating, updating and sharing information with other users of the system.

### BRIEF DESCRIPTION OF THE FIGURES

FIG. 1 is a flow chart that describes one aspect of the present invention whereby a user of the system and method of the present invention invites another user of the present invention to connect on the system.

FIG. 2 is a flow chart that shows how a first user of the present invention may request a second user of the present invention to introduce the first user to one of the second user's contacts.

FIG. 3 is a flow chart showing how a database may be updated with new contact information on an ongoing basis.

FIG. 4a-d shows one possible embodiment of the various actions, and associated work flows, a user can take once logged into the application.

FIG. 5 shows one possible embodiment of a sign-in screen that may be used in conjunction with the present invention.

FIG. 6 shows one possible embodiment of an interface that may be used to add contacts in conjunction with the present invention.

FIG. 7 shows one possible embodiment of an interface that may be used to view contacts in conjunction with the present invention.

FIG. 8 shows one possible embodiment of a networking interface that may be used in conjunction with the present invention.

FIG. 9 shows one possible embodiment of a notification interface that may be used in conjunction with the present invention.

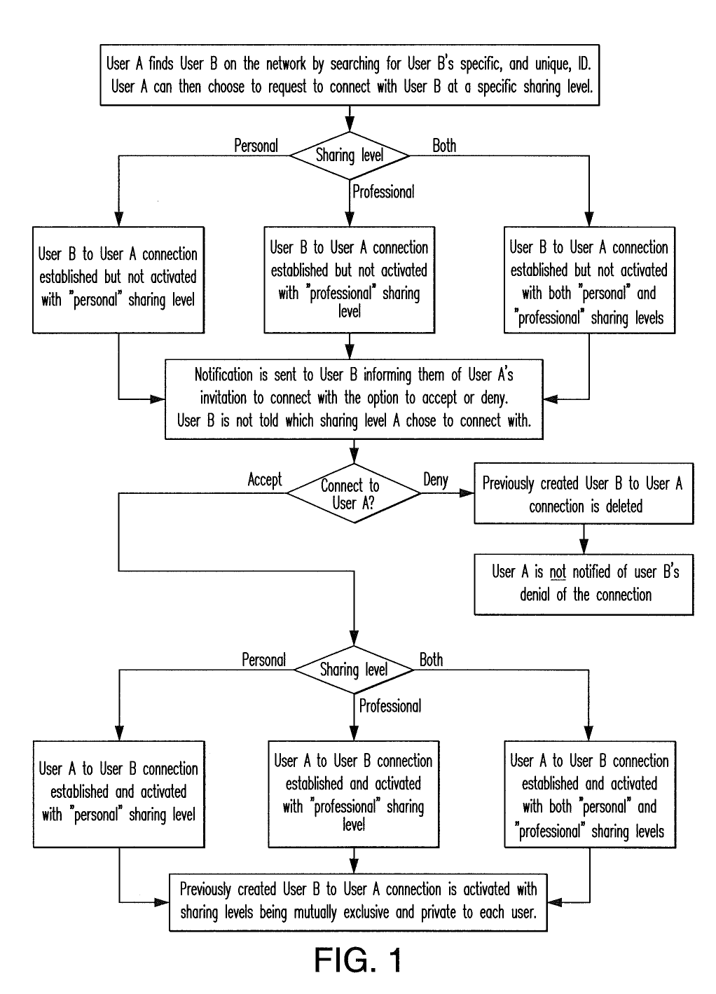

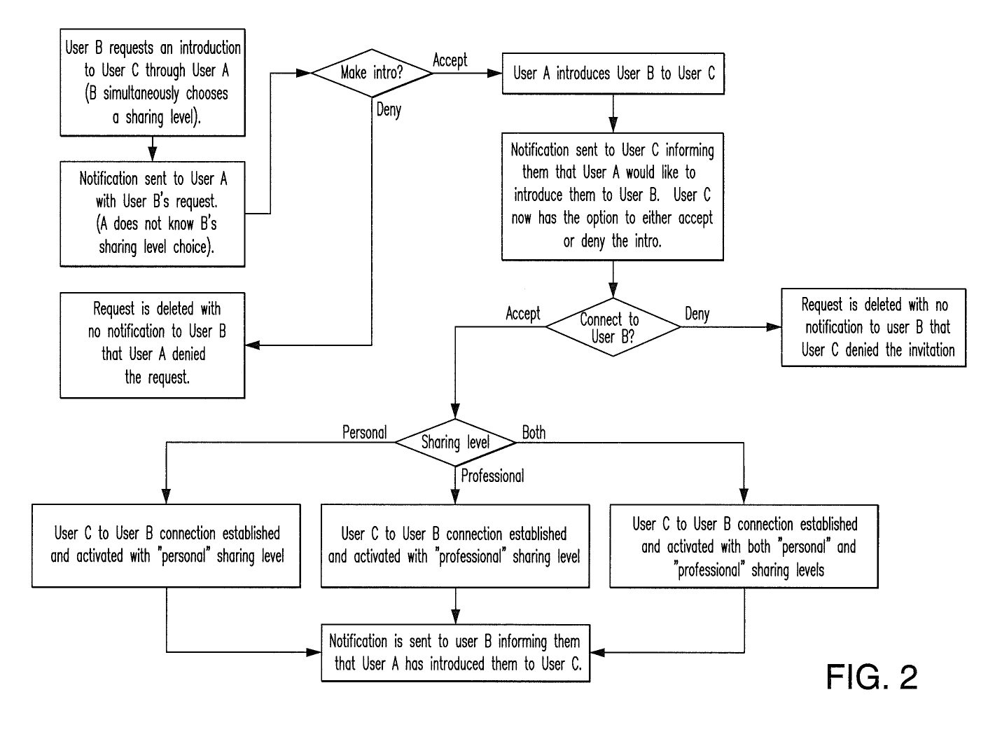

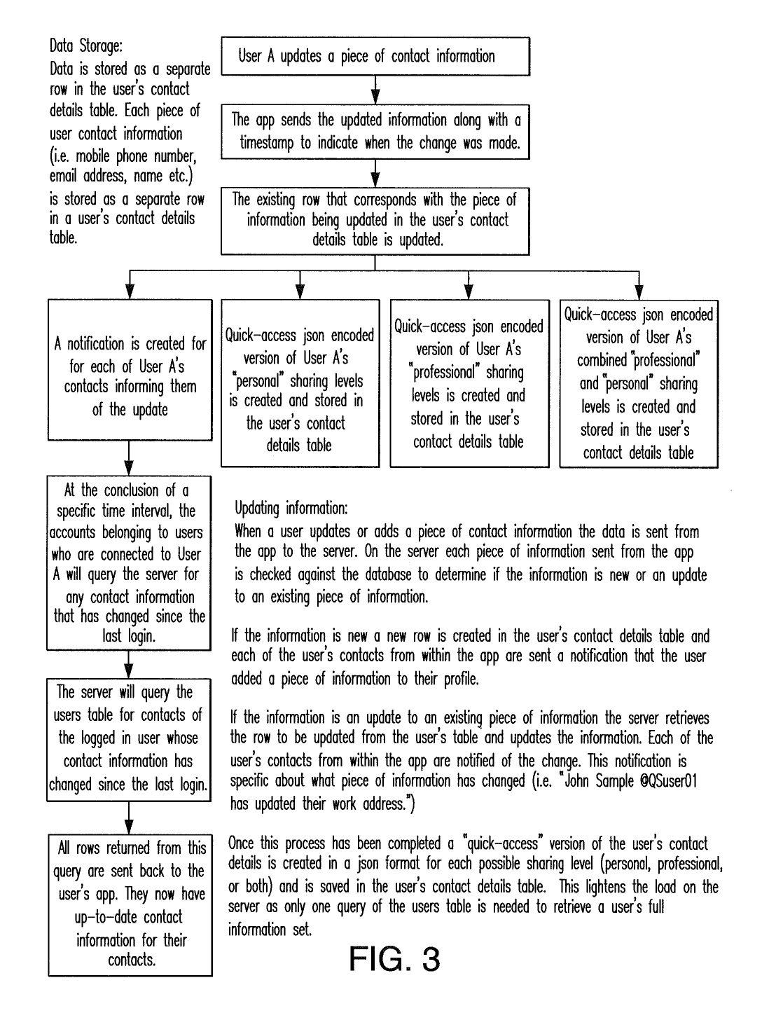

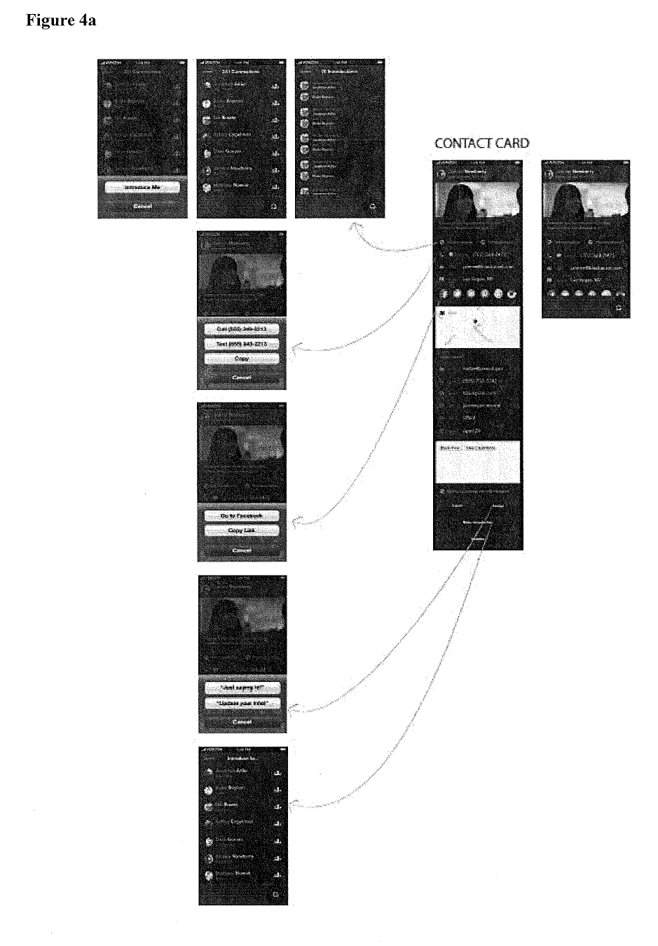

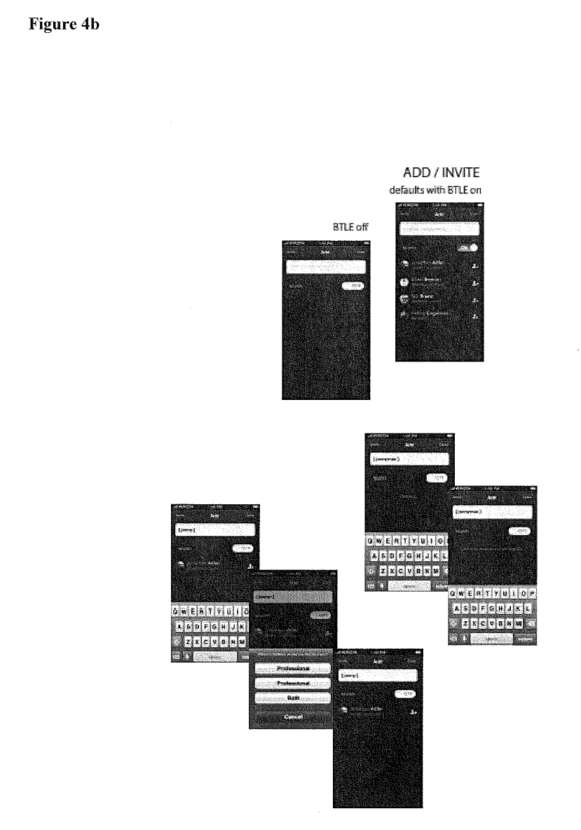

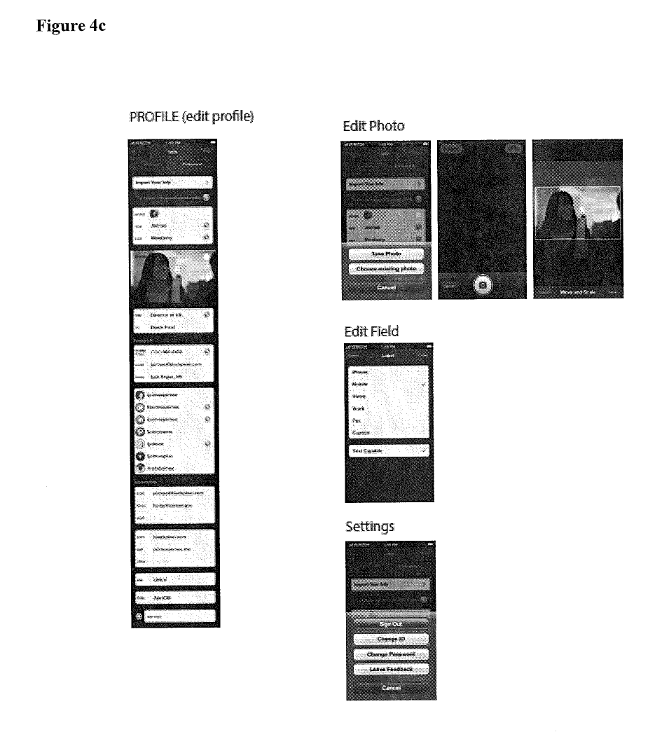

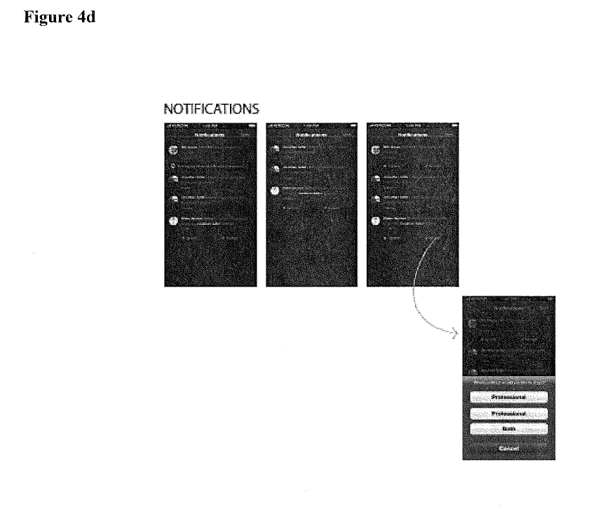

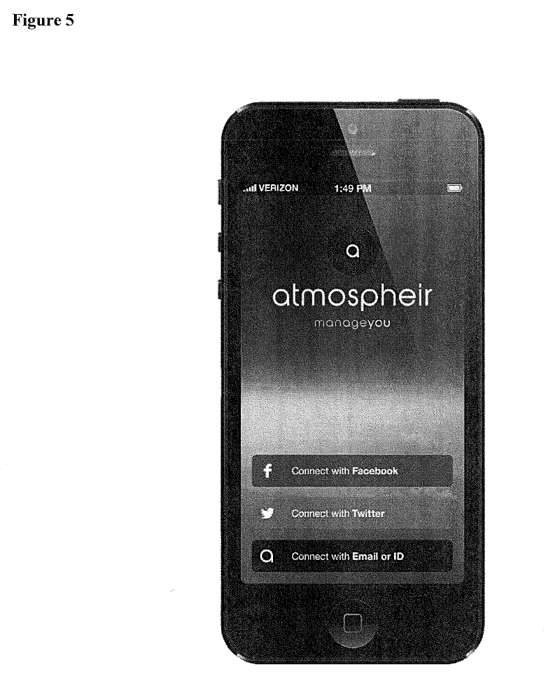

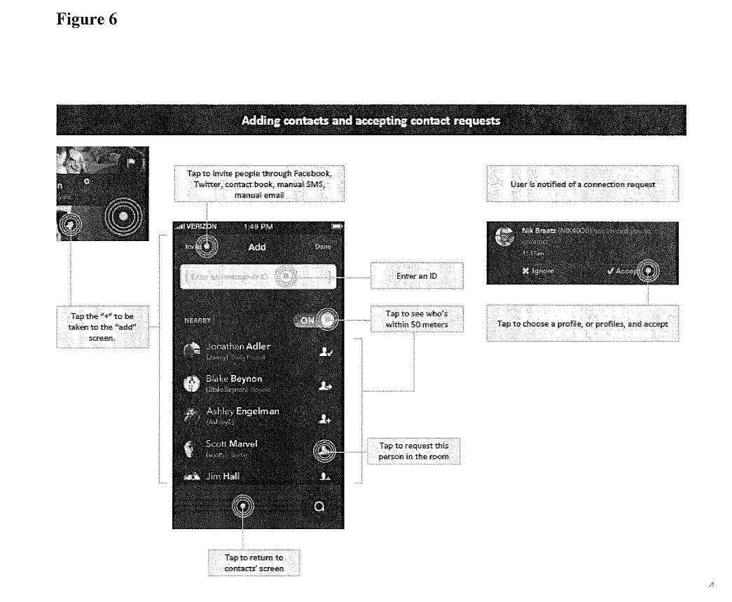

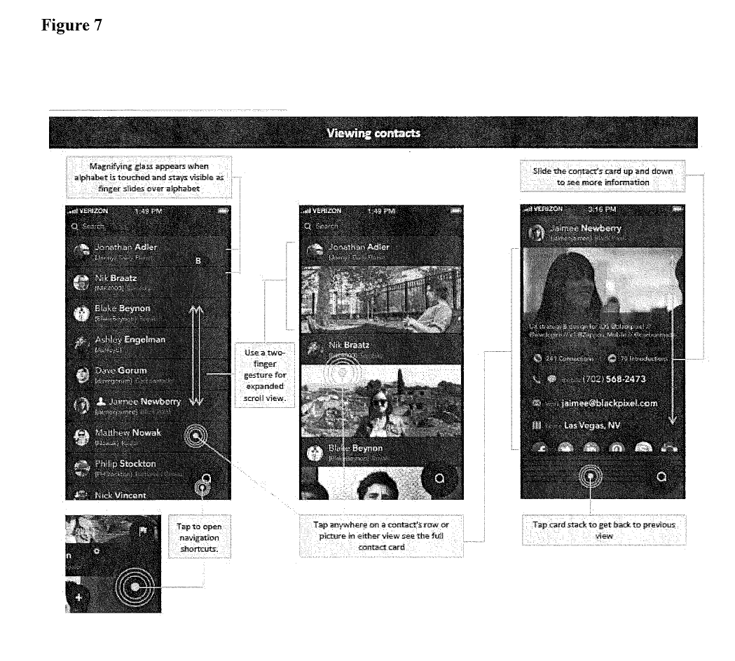

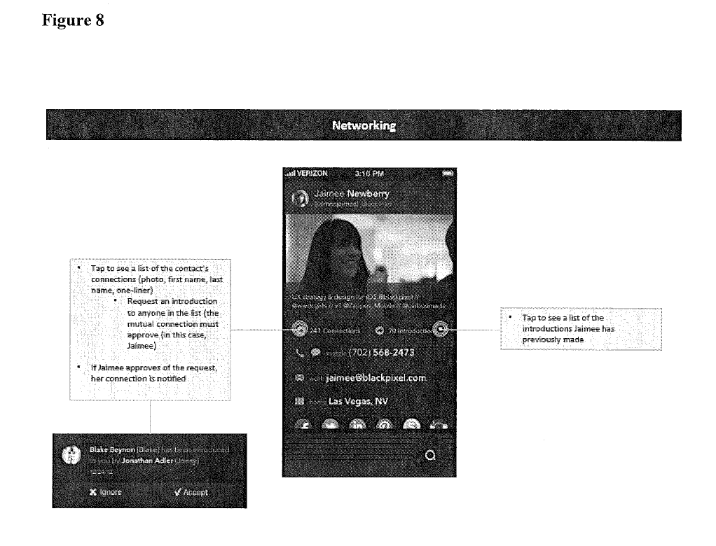

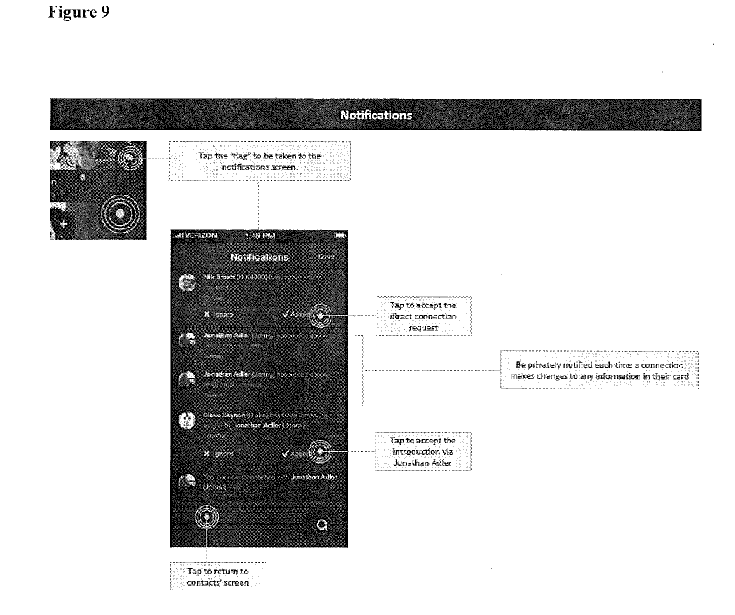

### DETAILED DESCRIPTION OF THE INVENTION

For simplicity and illustrative purposes, the principles of the present invention are described by referring to various exemplary embodiments thereof. Although the preferred embodiments of the invention are particularly disclosed herein, one of ordinary skill in the art will readily recognize that the same principles are equally applicable to, and can be implemented in other systems, and that any such variation would be within such modifications that do not part from the scope of the present invention. Before explaining the disclosed embodiments of the present invention in detail, it is to be understood that the invention is not limited in its application to the details of any particular arrangement shown, since the invention is capable of other embodiments. The terminology used herein is for the purpose of description and not of limitation. Further, although certain methods are described with reference to certain steps that are presented herein in certain order, in many instances, these steps may be performed in any order as would be appreciated by one skilled in the art, and the methods are not limited to the particular arrangement of steps disclosed herein.

For the first time, all the pieces needed for a complete personal and professional contact management system exist and are brought together. The present invention allows users to be located, and to then choose to exchange distinct and complete information profiles, primarily, by means of their unique user ID. Network structures associated with the present invention allow users to manage themselves and contacts as relationships and information changes. Mobile interfaces allow users to access, utilize, and edit contact information anytime and anywhere. Users of the present invention may also communicate with fellow users via a robust Over The Top (OTT) communication suite. The OTT communication suite features asynchronous communication tools, such as messaging, and synchronous communication tools, such as video teleconferencing. Notifications allow users to monitor network activity, receive and respond to requests from fellow users and discover when contacts add to or update their information.

Systems in accordance with the present invention may be network-based and may be accessed by users by way of accounts created on a server. Upon completing the account creation process, users are prompted to populate distinct and “themed” information profiles. Although the information profiles are distinct and are populated and maintained separately, users have the option of making specific pieces of information appear in both information profiles by clicking a button that makes that specific piece of information ubiquitous across all profiles. That button is available for each piece of information in a user's profile, which makes updating and creating both profiles fast and simple.

The information populated in the information profiles is focused on contact information including but not limited to phone numbers, email addresses, physical addresses, websites, and social media handles, referred to herein as “communication channels”. The types of information that can be included in a profile will evolve to include future forms of communication and social media handles.

Established contacts of users and all other users of the app cannot manipulate or edit the information contained in a user's information profiles, which makes each user the true master of his or her own information. Each user can, however, add “tags” to each of their contacts, which will allow them to be readily located within a user's contact list. Users can also add contacts to their “VIP” lists by tapping the “VIP” button located at the top right corner of said user's card. Each user's full information profiles are private in that they:
a. Cannot be viewed by other users of the app absent the mutual sharing of information profiles between users and a user cannot be added as a contact absent mutual sharing between users.
b. Cannot be shared by other users with non-users of the app.
c. Cannot be automatically shared with users of the app by established contacts within the app (established contacts can only provide their contacts with a means to request to connect with their other contacts by approving their introduction requests).

Users can be requested to connect with other users in three ways: (1) another user searches for their unique ID, finds them, and then requests a connection; (2) one of their already-established connections has permitted another user an introduction; or (3) they have chosen to make themselves visible to other users in the near vicinity via Bluetooth or some other location-based, near vicinity, technology.

Invitations to join the platform, however, may be sent by many means, including but not limited to email, SMS, Facebook, Twitter, and Linkedin. Users can also share a snapshot of their information profile via email or SMS.

A unique ID is not tied to any means of communication and remains constant, absent a request to change it made by the user. When changed, all of the changing user's previously established connections and populated information will be automatically transported over to the new ID.

A user's unique ID does not provide access to that user's information; rather, it affords the user in possession of the ID the ability to request a connection with the user whose ID they posses. During the connection request process, users will always have the ability to choose a specific sharing level with the other user. The sharing level can be mutually exclusive (i.e. the connected parties don't have to be sharing the same level).

The present invention can be implemented in an array of compatible software and hardware configurations including, but not limited to, the iOS iPhone software hardware configuration.

### IN-APPLICATION PROCESSES

Once a user completes the profile population process, they can begin connecting with fellow users as follows. For signposting purposes, in the following example, Alex, whose ID is @alex, will be connecting with Matt, whose ID is @matt. Alex is in possession of Matt's unique ID.
1. Alex enters Matt's ID in the “enter ID” field found on the “Add” screen, where users search for other users by their unique ID.
2. Hitting the “search” key sends user Matt's ID to the server and initiates a query that searches for the account associated with the ID @matt.
3. Once the server locates the account associated with ID @matt, it sends a specific combination of information, including at least Matt's First Name, Last Name and profile picture, back to Alex's app, which is displayed below the search bar on Alex's Add screen.
4. Alex taps on the “add” icon located next to Matt's information, triggering a pull-up menu to appear displaying the various sharing levels Alex can choose from when requesting to connect with Matt (original “themes” will include personal profile, professional profile and both profiles).
5. Alex can choose from any of the sharing levels when requesting to connect with Matt, however, for the purpose of this example Alex chooses the professional sharing level by tapping “professional” on the pull-up menu.
6. Alex tapping “professional” triggers the app to send information pertaining to this action, which includes Alex's ID, Matt's ID and which profiles Alex wants to share with Matt, to the server.
7. Upon arrival at the server, an Alex to Matt connection with the “professional sharing” level is established but NOT activated. Matt cannot view/access the information Alex has chosen to share with him (his professional profile) until the connection between them is activated, which occurs when Matt shares his information back (mutual sharing occurs).
8. The establishing of the connection between Alex and Matt triggers a notification to be sent from the server to Matt's App. The notification lands on the notifications screen and reads, “@alex has invited you to connect”, or something along those lines. Note that the notification does not detail the title of the profile Alex has chosen to share with Matt—the title(s)/theme(s) of profile(s) being shared with a user is/are always hidden from the user receiving the notification. The notification has a time stamp and below the notification there are “Accept” and “Ignore” buttons.
9. If Matt selects ignore, the app sends his action back to the server, which deletes the previously established server side Alex to Matt connection. The notification disappears from Matt's notification list on Matt's app and nothing is sent back to Alex's app.
10. If Matt hits accept, a pull-up menu appears displaying the various sharing levels (personal profile, professional profile and both profiles) he can choose from when responding to Alex's connection request. Matt cannot see the information Alex has chosen to share before deciding what to share back because, at this point, mutual sharing, and a connection, have not been achieved.
11. Matt can choose from any of the three sharing levels when responding to Alex (his choice does not have to mimic Alex's choice). For the purpose of this example, Matt chooses to respond to Alex's request with the “both” sharing level by tapping the “both” button on the pull-up menu.
12. Matt tapping “both” triggers the app to send his response to the server. Upon arrival at the server, the connection between Matt and Alex is activated whereby Alex is sharing his professional profile with Matt, and Matt is sharing both of his profiles with Alex.
13. The activation of the connection between Alex and Matt triggers the following actions which occur in conjunction with one another:
   The “quick access” version of Alex's contact details, which exists in a json format and is located in Alex's contact details table, for the “professional” sharing level is sent to Matt's App. This information is then displayed in a single profile as a contact in Matt's list of contacts. The sharing level label, in this case “professional”, is hidden from Matt. The sharing level label in a contact is always hidden from users whom information profile(s) were shared with.
   The ‘quick access’ version of Matt's contact details, which exists in a json format and is located in Matt's contact details table, for the “both” sharing level is sent to Alex's App. This information is then displayed in a single profile as a contact in Alex's list of contacts. The sharing level label, in this case “both”, is hidden from Alex.
   The notification found in Matt's profile which initially read “@alex has invited you to connect”, is changed to “Sharing both profiles with this person”.
   A notification appears on Alex's notification that reads “Matt @matt has accepted your invitation to connect”.
   As is detailed in the above four bullets, users always know, via notifications and via a button at the bottom of their contact's profiles, which profiles they are sharing with a contact, however, the receiving contact never knows the title(s) or theme(s) of the profile(s) being shared with them.

### CHANGING/ADDING INFORMATION AFTER A CONNECTION IS ESTABLISHED

If either Alex or Matt updates the information in the profiles they share with one another or add information to the profiles they share with one another, their respective contacts for one another automatically update via the following process:
1. When a user updates or adds contact information to one or both of their profiles, the updated/additional data is sent from the app to the server.
2. Upon arrival at the server, each piece of information sent from the app is checked against the user's contact details table to determine if the information is new or an update to something existing.
3. If the information is new, a new row is created in the user's contact details table and each of the users contacts from within the app who have permission to view the profile(s) where the data was added are sent a notification that the user has added a piece of information. Clicking on the notification will take the user to the contact for the user who added information.
4. If the information is an update to something existing, the server retrieves the row where the information that is being updated is stored and updates the information in that row. Each of the user's contacts from within the app who have permission to view the profile(s) where the data was updated are sent a notification that the user has updated a piece of information. Clicking on the notification will take the user to the contact for the user who updated information.
5. Once the information has been updated or added to the user's contact details table, a “quick access” version of the user's contact details is created in a json format for each possible sharing level (personal, professional or both).
6. Every time a user visits their list of contacts, or every time a specified time interval elapses during an app session, or every time a user logs into the app, the user's app will query the server to see if the sharing levels they have been granted contain profiles with updated or additional information. If the sharing level a user has been granted contains profiles updated or additional information, the server will resend the appropriate “quick access” profile to the user's app, which will replace the existing, and now dated, contact they had for the user who updated or added information to their profile(s). This process is fully automated, does not require an acceptance on behalf of the user receiving the update, and the user receiving the update does not have the option of rejecting the update.

### ADJUSTING SHARING LEVELS

Once a user has established a connection with another user they can adjust which profiles they are sharing with that user at any time: Adjustments include sharing an additional profile, revoking a profile already being shared (only applies if they were initially sharing both), or swapping the profiles being shared with that user. The process is as follows:
1. From the contact list, select the contact that you want to adjust your sharing permissions with.
2. At the bottom of that contact's profile, click the “sharing with” button.
3. Clicking this button triggers a pop-up menu to appear that displays the three sharing levels a user can choose from when connecting with a fellow user.
4. Once you have selected the new desired sharing level, the app sends your new preference to the server.
5. The server queries your table for the contact in question and adjusts the sharing level that governs your connection with them.
6. Once the new sharing level is established on the server side, a notification is sent to the user whose sharing level has been adjusted that informs them that new information has been shared with them. They are not told the names of the new profiles being shared, if information was revoked or if information has been “swapped”.
7. Every time a user visits their list of contacts, or every time a specified time interval elapses during an app session, or every time a user logs into the app, the user's app will query the server to see if the sharing levels they have been granted have been adjusted. If the sharing level a user has been granted has been adjusted, the server will resend the “quick access” profile that corresponds with the new sharing level they have been granted to the user's app, which will replace the existing contact they had for the user who has adjusted the sharing level. This process is fully automated, does not require an acceptance on behalf of the user who has been granted a new sharing level, and the user who has been granted the new sharing level does not have the option of rejecting the adjustment. Moreover, the user who adjusted the sharing level does not have the option of retracting the adjustment they made in case of error; if they made a mistake, they would simply have to readjust the sharing level again.

### DELETING A CONTACT

1. From the contact list, select the contact you want to delete.
2. At the bottom of that contact's profile, click the “remove” button.
3. Clicking this button automatically removes the contact from your list.
4. Simultaneously, the remove action is sent to the server. The server queries your table for the connection that governs the contact whom you want to delete.
5. Once the connection is located, it is deleted.
6. The next time the user visits their list of contacts, or every time a specified time interval elapses during an app session, or every time a user logs into the app, the user's app will query the server to see if the sharing levels they have been granted have been removed. If a sharing level has been removed, the contact corresponding with this sharing level will be removed from the users contact list.

While the invention has been described with reference to certain exemplary embodiments thereof, those skilled in the art may make various modifications to the described embodiments of the invention without departing from the scope of the invention. The terms and descriptions used herein are set forth by way of illustration only and not meant as limitations. In particular, although the present invention has been described by way of examples, a variety of compositions and processes would practice the inventive concepts described herein. Although the invention has been described and disclosed in various terms and certain embodiments, the scope of the invention is not intended to be, nor should it be deemed to be, limited thereby and such other modifications or embodiments as may be suggested by the teachings herein are particularly reserved, especially as they fall within the breadth and scope of the claims here appended. Those skilled in the art will recognize that these and other variations are possible within the scope of the invention as defined in the following claims and their equivalents.

What is claimed is:

1. A private network-based system for managing and sharing personal and professional contact information comprising;
at least one processor,
at least one user interface for imputing user data,
at least one database for storing user data, and
unique user created IDs tied to stored user data,
availability of at least two profiles tied to each unique user's ID,
wherein the system is configured to assist users in storing, locating, updating and sharing information with other users of the system.

2. The private network-based system of claim 1, wherein the system is further configured to allow users to share information.

3. The private network-based system of claim 1, further comprising at least one hand-held device.

4. The private network-based system of claim 1, wherein the user interface comprises a graphic user interface.

5. The private network-based system of claim 1, wherein the system is further configured to allow users to invite non-users to join the private network-based system.

6. The private network-based system of claim 3, wherein the hand-held device comprises a graphic user interface.

7. The private network-based system of claim 1, wherein the system is configured to allow a user to choose the level of information sharing between the user and other users of the system.

8. The private network-based system of claim 1, wherein the system is configured to allow users to locate, connect and communicate with other users of the system via a Bluetooth connection.

9. The private network based system of claim 1, wherein the system is configured to allow users to control the privacy associated with and access to their information.
